(19) United States
(12) Patent Application Publication
(10) Pub. No.: US 2025/0361774 A1
(43) Pub. Date: Nov. 27, 2025

(54) AQUATIC STAIRS

(71) Applicant: Summerset Marine Construction, Whitewater, WI (US)

(72) Inventor: Larry Chapman, East Troy, WI (US)

(73) Assignee: Summerset Marine Construction, Whitewater, WI (US)

(21) Appl. No.: 18/669,964

(22) Filed: May 21, 2024

(51) Int. Cl. E06C 9/08

(52) U.S. Cl. CPC E06C 9/08

(57) ABSTRACT

Aquatic stairs for marine environments are disclosed. The aquatic stairs comprise: a staircase; and an aquatic stair system for elevating a staircase from a body of water. The aquatic stair system includes: a hinge mechanism for attaching the staircase to a support structure; and an actuator operatively connected to the staircase for transitioning the staircase between submerged and elevated positions.

### TECHNICAL FIELD

The present disclosure generally relates to marine equipment, and more particularly relates to stairs for aquatic environments.

### BACKGROUND

Marine environments present unique challenges to infrastructure, particularly when it comes to providing safe and reliable access between land and water. Aquatic stairs, serving as critical conduits in this regard, are subject to a range of environmental stresses, including tidal fluctuations, waterborne debris, and the corrosive effects of saltwater. The traditional approach to marine access has largely revolved around fixed stair systems, which, while providing a stable means of access, suffer from several drawbacks, primarily related to their static nature. Fixed stairs are constantly exposed to water, making them susceptible to damage from ice formation in colder climates and biofouling in warmer regions, which can compromise safety and longevity.

The concept of adjustable or movable aquatic stairs is not new; however, existing solutions often involve manual adjustment mechanisms that require significant physical effort and do not offer the ease of use necessary for wide adoption. Electrically or mechanically actuated systems have been developed but tend to be complex, expensive, and require substantial maintenance.

In light of these challenges, there exists a need for an innovative marine stair system that combines the stability and reliability of fixed stairs with the adaptability of movable systems. Such a system would ideally offer consistent access while minimizing the risk of damage from environmental exposure. Moreover, a design that emphasizes simplicity, durability, and low maintenance would address many of the shortcomings associated with current solutions, making safe and convenient marine access more accessible to a broader range of users and applications.

Others have attempted to address the challenges associated with marine access systems, as evidenced by various patents and applications in the field. For instance, the OPACMARE patent, identified as U.S. Pat. No. 11,608,143, introduces a movable platform assembly for boats, featuring a design centered on horizontal translation mechanisms for extending and retracting platforms. The system employs rotatable arms and slidable sliders for extending and retracting the platform. However, this design primarily caters to horizontal adjustments and does not directly address the challenges posed by vertical adjustments necessary for combating environmental impacts like ice formation or biofouling.

Hence, there exists a need for an innovative marine access system that adeptly adjusts to fluctuating water levels, mitigating the challenges posed by environmental conditions such as ice formation and biofouling, while ensuring safe, reliable, and user-friendly access to aquatic environments.

### SUMMARY

In accordance with one aspect of the disclosure, aquatic stairs for marine environments are disclosed. The aquatic stairs comprise: a staircase; and an aquatic stair system for elevating a staircase from a body of water. The aquatic stair system includes: a hinge mechanism for attaching the staircase to a support structure; and an actuator operatively connected to the staircase for transitioning the staircase between submerged and elevated positions.

In accordance with another aspect of the disclosure, an aquatic stair system for transitioning a staircase between elevated and submerged positions relative to a body of water is disclosed. The aquatic stair system comprises: an actuator mounted to a support structure, wherein the actuator is capable of extending and retracting to adjust the orientation of the staircase; a hinge mechanism attached to the support structure and operatively connected to the staircase, facilitating pivotal movement of the staircase in response to the actuation; a control unit configured to command the actuator based on desired staircase orientation.

In accordance with another aspect of the disclosure, a method for adjusting a position of aquatic stairs relative to a body of water is disclosed. The method comprises: providing the aquatic stairs with a hinge mechanism at a first end of a staircase, the hinge mechanism is pivotably mounted to a support structure, and providing an actuator mounted on an anchor and connected to the staircase; activating an actuator connected to the staircase; pivoting the staircase using a hinge mechanism; and controlling the actuator based on desired staircase orientation.

These and other aspects and features of the present disclosure will be better understood upon reading the following detailed description when read in conjunction with the accompanying drawings.

### BRIEF DESCRIPTION OF THE DRAWINGS

FIG. 1 is a schematic view of a support structure and aquatic stairs in an access orientation, according to an embodiment of the present disclosure.

FIG. 2 is a schematic view of a support structure and aquatic stairs of FIG. 1 in a lifted orientation, according to an embodiment of the present disclosure.

FIG. 3 is a schematic close-up view of an actuator connected to the support structure and the aquatic stairs of FIG. 1, according to an embodiment of the present disclosure.

FIG. 4 is a perspective rear view of the actuator connected to the support structure and the aquatic stairs of FIG. 1, according to an embodiment of the present disclosure.

FIG. 5 is a perspective side view of the actuator connected to the support structure and the aquatic stairs of FIG. 1, according to an embodiment of the present disclosure.

FIG. 6 is a block diagram of a stair raiser system for controlling the aquatic stairs of FIG. 1, according to an embodiment of the present disclosure.

FIG. 7 is a perspective view of a hinge mechanism connecting the aquatic stairs of FIG. 1 to the support structure, according to an embodiment of the present disclosure.

FIG. 8 is a perspective rear view of a female bracket of the hinge mechanism of FIG. 6, according to an embodiment of the present disclosure.

FIG. 9 is a perspective rear view of a male bracket of the hinge mechanism of FIG. 6, according to an embodiment of the present disclosure.

FIG. 10 is a perspective top view of the hinge mechanism, according to an embodiment of the present disclosure.

FIG. 11 is a perspective side view of the hinge mechanism, according to an embodiment of the present disclosure.

FIG. 12 is a perspective front view of the hinge mechanism below the aquatic stairs of FIG. 1, according to an embodiment of the present disclosure.

FIG. 13 is a perspective top view of the hinge mechanism connecting the aquatic stairs of FIG. 1 to the support structure, according to an embodiment of the present disclosure.

FIG. 14 is a schematic side view of the hinge mechanism connecting the aquatic stairs of FIG. 1 to the support structure, according to an embodiment of the present disclosure.

FIG. 15 is a perspective top view of the support structure and aquatic stairs of FIG. 1 illustrating the actuator, according to an embodiment of the present disclosure.

FIG. 16 is a perspective close-up view of the actuator connected in the aquatic stairs of FIG. 15, according to an embodiment of the present disclosure.

FIG. 17 is a perspective isolated view of the actuator connected to the anchor, according to an embodiment of the present disclosure.

FIG. 18 is a perspective view of an actuator bracket, according to an embodiment of the present disclosure.

FIG. 19 is a schematic rear view of the aquatic stairs of FIG. 1 in the access orientation, according to an embodiment of the present disclosure.

FIG. 20 is a schematic front view of the actuator bracket, according to an embodiment of the present disclosure.

FIG. 21 is a schematic rear view of the aquatic stairs of FIG. 1 in the access orientation, according to an embodiment of the present disclosure.

FIG. 22 is a perspective top view of the support structure and aquatic stairs of FIG. 1 in the lifted orientation, according to an embodiment of the present disclosure.

FIG. 23 is a flow-chart of a method of adjusting an aquatic staircase, according to an embodiment of the present disclosure.

The figures depict one embodiment of the presented invention for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, aquatic stairs 100 are displayed, illustrated as an exemplary means of facilitating access between aquatic and terrestrial environments. Aquatic stairs 100 are essential in various settings, notably residential docks or commercial marinas, where a robust and reliable transition between land and water is paramount. While the following detailed description focuses primarily on the aquatic stairs 100 in the context of aquatic environments, it should be appreciated that the principles and mechanisms discussed herein are applicable to similar structures designed for different environments and purposes, such as riverbank stairs, boat launch stairs, boat launches, swimming platforms, waterfront gangways, and other specialized access solutions in both marine and freshwater settings.

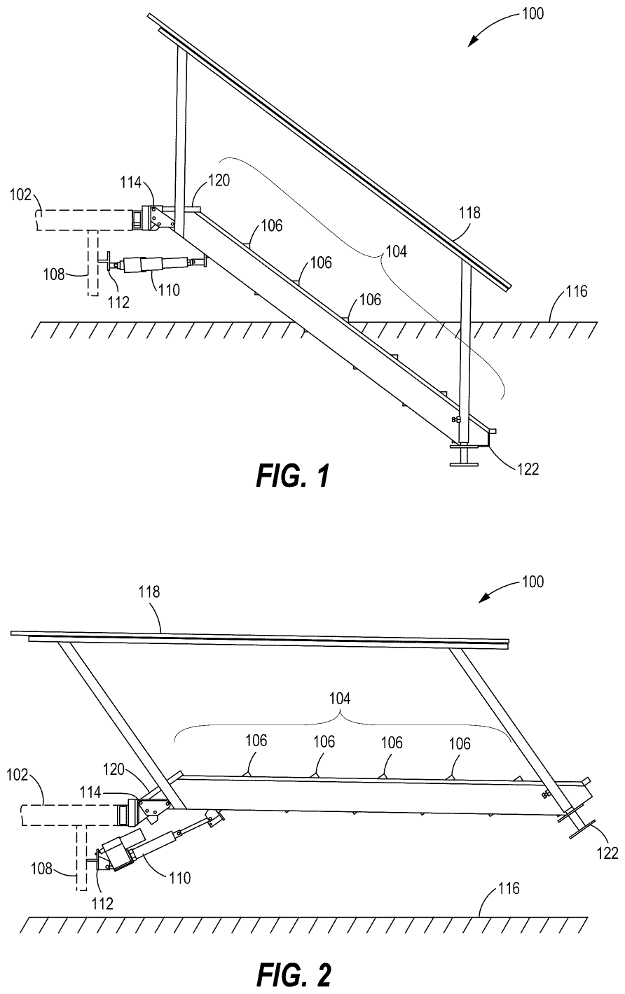

Referring now to FIG. 1, a schematic view of the aquatic stairs 100 is illustrated, according to an embodiment of the present disclosure. The aquatic stairs 100 are structured to facilitate access with and/or within aquatic environments. The aquatic stairs 100 are generally affixed to a support structure 102, which provides the necessary support and stability for the aquatic stairs 100. Attached to this support structure 102 is an anchor 108, acting as a mounting surface for other operational components to ensure their stability and functionality for the aquatic stairs 100. The aquatic stairs 100 includes a staircase 104, comprised of a series of stairs 106. The series of stairs 106 are designed to provide safe passage from one surface to another surface into water.

An actuator 110 connected to the aquatic stairs 100 is mounted onto the anchor 108. The actuator 110 is responsible for the movement of the staircase 104, allowing it to transition between submerged and elevated positions as required by environmental conditions or user needs. The actuator 110 is attached to the anchor 108 via an actuator bracket 112, which secures the actuator 110 in place and ensures correct alignment for its operation. Connected to the staircase 104 is a hinge mechanism 114 fastened to the support structure 102, enabling the pivotal movement necessary for adjusting the orientation of the aquatic stairs 100 above or submerged relative to a water line 116. This hinge mechanism 114 allows for the staircase 104 to be positioned according to user preferences or environmental requirements, such as varying lake bottoms.

Referring now to FIG. 2, the aquatic stairs 100 are shown in a lifted orientation, demonstrating the system's capability for elevation. The actuator 110 activates to elevate the staircase 104 above the water line 116, serving to protect the aquatic stairs 100 from environmental factors, such as algae growth, and to adapt access for users. The hinge mechanism 114 facilitates this transition, ensuring the staircase 104 can be efficiently positioned. To aid in user safety, a railing 118 is affixed to the staircase 104, offering support and stability for users navigating the staircase 104. A first end 120 of the aquatic stairs 100 is attached to the support structure 102 and a second end 122 is configured to submerge below the water line 116 or engage a lake bottom.

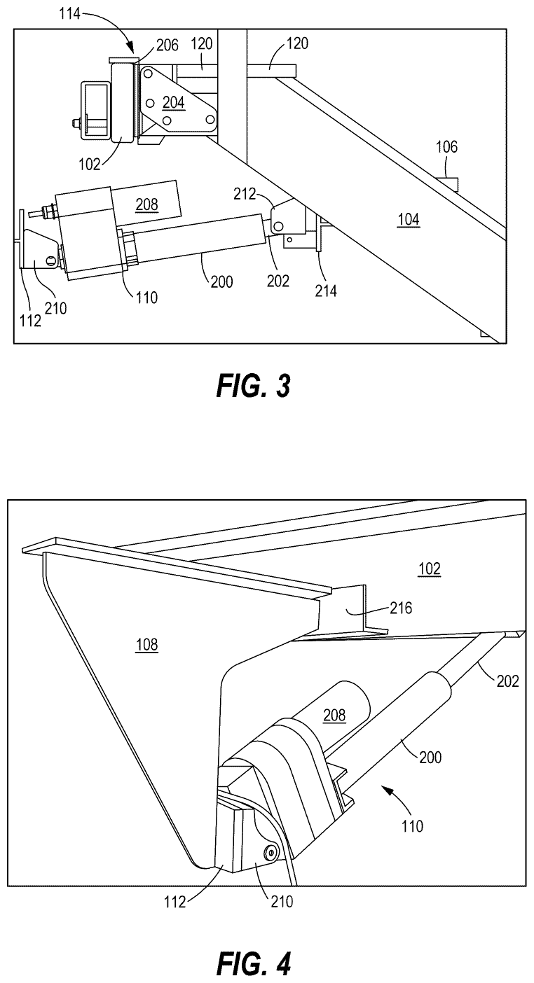

Referring now to FIG. 3, a schematic close-up view of the actuator 110 connected to the support structure 102 and the aquatic stairs 100 of FIG. 1 is detailed, according to an embodiment of the present disclosure. The actuator 110 is illustrated with an actuator cylinder 200, responsible for generating the linear motion required for the operation of the aquatic stairs 100. Within the actuator cylinder 200 operates an actuator rod 202, extending and retracting to facilitate the movement of the staircase 104 between elevated and submerged positions.

At the first end 120 of the aquatic stairs 100, a female bracket 204 is affixed, serving as part of the hinge mechanism 114 that connects the staircase 104 to the support structure 102. This female bracket 204 is configured to interlock with a male bracket 206, which in turn is connected to the support structure 102, establishing a pivotal junction that supports the rotational movement of the staircase 104 of the aquatic stairs 100.

An actuator sensor 208 may be incorporated into the actuator 110 to monitor the position of the actuator rod 202, providing real-time data on the orientation of the aquatic stairs 100. The actuator sensor 208 supports ensuring precise control over the positioning of the staircase 104, enabling adjustments to be made with accuracy.

Supporting the actuator 110's connection to the anchor 108 on the support structure 102 is a first actuator pivot bracket 210. The first actuator pivot bracket 210 allows the actuator cylinder 200 to pivot from the anchor 108 point, accommodating the changing angles of the staircase 104 as they move between positions. This pivoting action is essential for maintaining alignment and ensuring smooth operation.

Supporting the actuator 110's connection to the staircase 104 is a second actuator pivot bracket 212. The second actuator pivot bracket 212 allows the actuator cylinder 200 to pivot, accommodating the changing angles of the staircase 104 as they move between positions. This pivoting action is essential for maintaining alignment and ensuring smooth operation. Additionally, an actuator-stair bracket 214 secures the actuator rod 202 to the underside of the aquatic stairs 100 by fastening the second actuator pivot bracket 212 to the actuator-stair bracket 214. The second actuator pivot bracket 212 is shown facilitating the pivotal connection to the underside of the staircase 104, accommodating the actuator 110's movement and the changing angles as the staircase 104 transitions between positions. The actuator-stair bracket 214, securing the actuator rod 202 to the staircase 104, ensures the effective transfer of force from the actuator 110, enabling the lifting and lowering of the staircase 104. Additionally, a power-stairs bracket 216 is provided to connect the anchor 108 to the support structure 102.

Referring now to FIG. 4, a perspective rear view of the actuator 110 connected to the support structure 102 and the aquatic stairs 100 from FIG. 1 is provided, according to an embodiment of the present disclosure. The actuator cylinder 200 mounted on the anchor 108, visible in this rear perspective, serves as the primary component responsible for generating the linear motion necessary for adjusting the position of the aquatic stairs 100. Housed within the actuator cylinder 200, the actuator rod 202 is shown in a state of extension or retraction, influencing the elevation or lowering of the aquatic stairs 100.

The actuator sensor 208 may be provided on the actuator 110, strategically placed to monitor the displacement of the actuator rod 202. This sensor provides crucial data regarding the current position of the aquatic stairs 100, enabling precise adjustments to their orientation. The inclusion of the actuator sensor 208 exemplifies the system's capability for detailed monitoring and control, ensuring that the aquatic stairs 100 can be positioned with high accuracy.

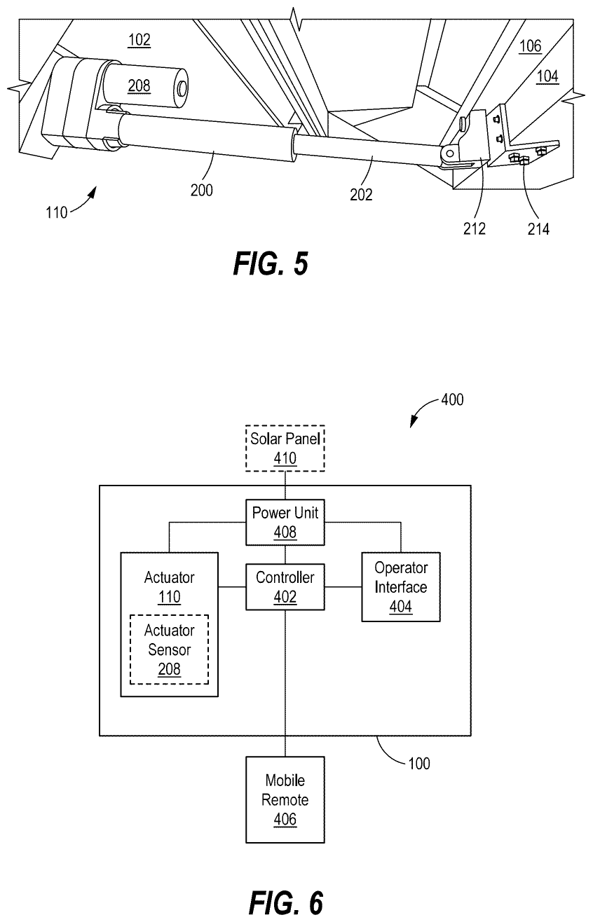

Referring now to FIG. 5, a perspective side view of the actuator 110 connected to the support structure 102 and the aquatic stairs 100 from FIG. 1 is presented, according to an embodiment of the present disclosure. The actuator rod 202 is depicted in a state of extension, illustrating its function in elevating or lowering the staircase 104 in response to control inputs. The actuator 110 is anchored securely at one end to the anchor 108, which is integrated with the support structure 102. This anchorage provides a stable and robust foundation for the actuator 102's operation, ensuring the delivery of consistent force for the movement of the staircase 104.

The actuator 110 is mounted at one end to the anchor 108, which is affixed to the support structure 102, providing a stable base for the actuator 110's operations. This mounting ensures that the actuator 110 is securely positioned to apply the necessary force for adjusting the staircase 104.

On the opposite end from where the actuator 110 mounts to the anchor 108, the second actuator pivot bracket 212 connects the actuator 110 to the underside of the staircase 104 by further connection to the actuator-stair bracket 214. This configuration allows for the pivotal movement of the actuator 110 in relation to the staircase 104, accommodating the varying angles as the staircase 104 transitions between different orientations. The second actuator pivot bracket 212 enables flexibility, ensuring that the actuator 110 can maintain a linear motion when lifting or lowering the staircase 104 while maintaining a secure connection. The actuator-stair bracket 214, in conjunction with the second actuator pivot bracket 212, secures the actuator rod 202 to the aquatic stairs 100, facilitating the effective transfer of mechanical force necessary for the movement of the staircase 104.

Referring now to FIG. 6, a block diagram of an aquatic stair system 400 is shown, illustrating the system designed for controlling the aquatic stairs 100 of FIG. 1, according to an embodiment of the present disclosure. A control unit 402 is provided in direct communication with the actuator 110 and the actuator sensor 208. The control unit 402 processes data received from the actuator sensor 208, which monitors the position of the actuator rod 202. This data allows the control unit 402 to determine the current orientation of the aquatic stairs 100 and make necessary adjustments through the actuator 110. The control unit 402 utilizes measurements such as the length of the actuator rod 202 extension or retraction to gauge the positioning of the staircase 104 accurately.

An operator interface 404 provides a user-accessible platform for manually controlling the operation of the aquatic stairs 100. This interface allows users to input desired positions for the staircase 104, which the control unit 402 then executes using the Actuator 110. The operator interface 404 is designed for intuitive use, enabling straightforward adjustments to the orientation of the staircase 104.

Additionally, the aquatic stair system 400 may further include a mobile remote 406 that communicates wirelessly with the control unit 402, allowing users to adjust the position of the staircase 104 from a distance, adding a layer of convenience to the operation of the aquatic stairs 100. The mobile remote 406 may be a phone, or other device, as generally known in the arts.

The control unit 402 in the aquatic stair system 400 may regulate mechanisms associated with adjusting the aquatic stairs 100. These mechanisms might include, but are not limited to, actuation systems for raising and lowering the staircase 104, hinge systems for pivotal movement, sensor systems for position feedback, and safety mechanisms to prevent damage or injury, as generally known in the arts. These systems can encompass a variety of hydraulic, mechanical, electronic, and software-based components, which the control unit 402 can communicate with and control, as generally known in the arts. The mobile remote 406 could be utilized to interact with the control unit 402, possibly through a wireless network, to manage the operation of these mechanisms and ensure the aquatic stairs 100 are adjusted to any angled degree or orientation, safely and efficiently according to the user's needs.

The aquatic stair system 400 provides an automated framework for managing the aquatic stairs 100, leveraging advanced control mechanisms and precise operations of the actuator 110 to ensure the staircase 104 can be positioned effectively to meet user needs and adapt to environmental conditions. The integration of the control unit 402 with the actuator 110, actuator sensor 208, operator interface 404, and mobile remote 406 illustrates a comprehensive approach to controlling the aquatic stairs 100, ensuring their functionality and accessibility in aquatic environments.

Incorporated within the aquatic stair system 400 is a power unit 408, which may be constituted by a battery, configured to power the control unit 402 and operator interface 404. The operator interface 404 may be a switch to actuate the actuator 110 and facilitate the positional adjustment of staircase 104. Additionally, the power unit 408 may be augmented by a solar panel 410, effectively harnessing solar energy to supplement or recharge the battery, thereby promoting energy efficiency and sustainability. The assembly of power unit 408, optionally in conjunction with solar panel 410, is strategically mounted on staircase 104.

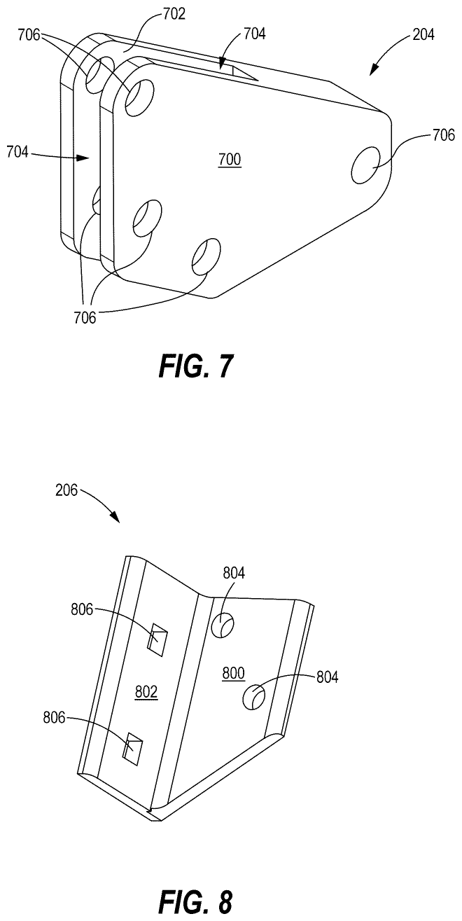

Referring now to FIG. 7, a perspective view of the female bracket 204, a part of the hinge mechanism 114, is presented, according to an embodiment of the present disclosure. This bracket incorporates both a first leaf 700 and a second leaf 702, designed to offer not only structural support but also to enable the pivotal movement essential for the operation of the aquatic stairs 100. The integration of a receiving slot 704 within the female bracket 204 is configured to accommodate the male bracket 206, facilitating a secure yet flexible connection. Additionally, the presence of a plurality of female slots 706 allows for the precise placement of fasteners, securing the bracket firmly to the first end 120 of the aquatic stairs 100 and ensuring stability and proper alignment within the hinge mechanism 114 during the lifting and lowering process of the aquatic stairs 100.

Referring now to FIG. 8, a perspective rear view of the male bracket 206 of the hinge mechanism 114 is depicted, according to an embodiment of the present disclosure. This bracket is characterized by an L-shaped structure, formed by the first foil 800 and the second foil 802, which is essential for providing a strong mounting point to the support structure 102 and ensuring an even load distribution. The male bracket 206 is equipped with a plurality of male slots 804 for the insertion of fasteners, which facilitate its secure attachment to the support structure 102. Additionally, the arrangement of mounting slots 806 on the male bracket 206 is key to its engagement with the female bracket 204, enabling the hinge mechanism 114 to support the rotational movement of the aquatic stairs 100 as they adjust between positions.

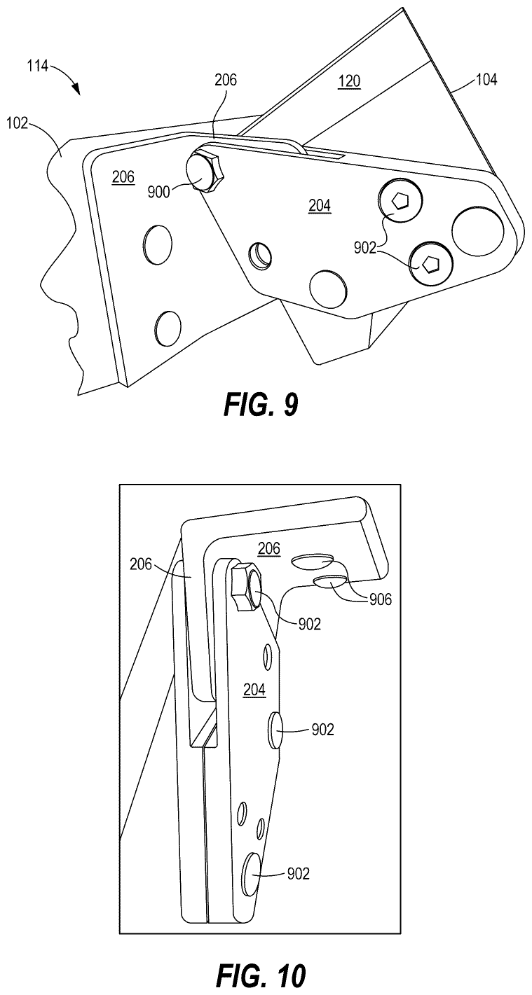

Referring now to FIG. 9, the assembly of the hinge mechanism 114 connected to the support structure 102 is depicted, according to an embodiment of the present disclosure. This view highlights the dynamic interaction between the female bracket 204 and the male bracket 206, illustrating how the female bracket 204 is securely fastened to the male bracket 206 using a series of first fasteners 900. These fasteners engage the male slots 804, providing a stable base for the hinge mechanism 114. Furthermore, the connection between the female bracket 204 and the aquatic stairs 100 is reinforced by second fasteners 902, which thread through the female slots 706, ensuring the stability and functionality of the hinge mechanism 114 as it facilitates the aquatic stairs 100 in transitioning between their various orientations.

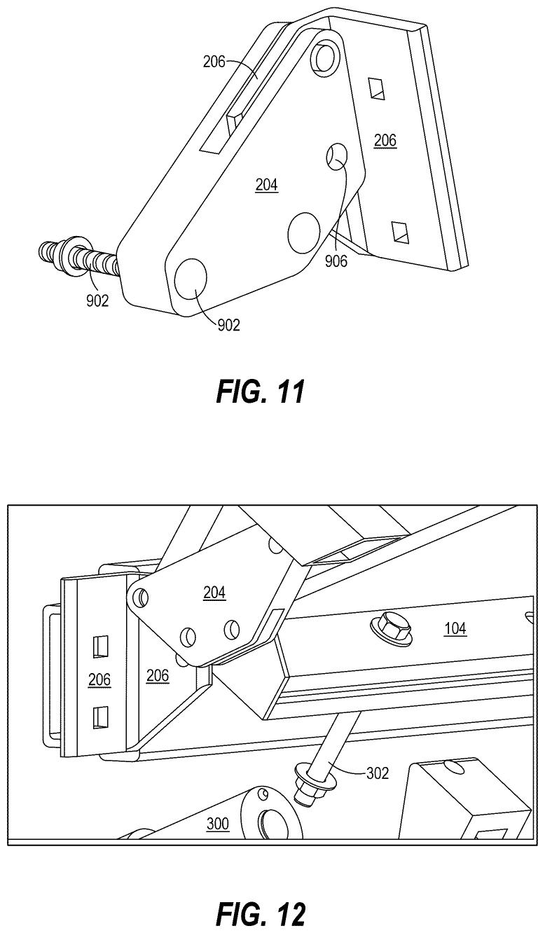

Referring now to FIGS. 10-11, the top view and side view of the hinge mechanism 114 is depicted, according to an embodiment of the present disclosure. The arrangement highlights how the female bracket 204's first leaf 700 and second leaf 702 align with the male bracket 206's first foil 800 and second foil 802, ensuring a robust connection that supports the aquatic stairs 100′ 100 pivotal movement. This assembly facilitates the hinge mechanism 114 in providing the rotational movement necessary for the aquatic stairs 100 as they are raised and lowered, adapting to the varying requirements of users and the environment. The male bracket 206 may be securely fastened to the support structure 102 via plurality of frame fasteners 906.

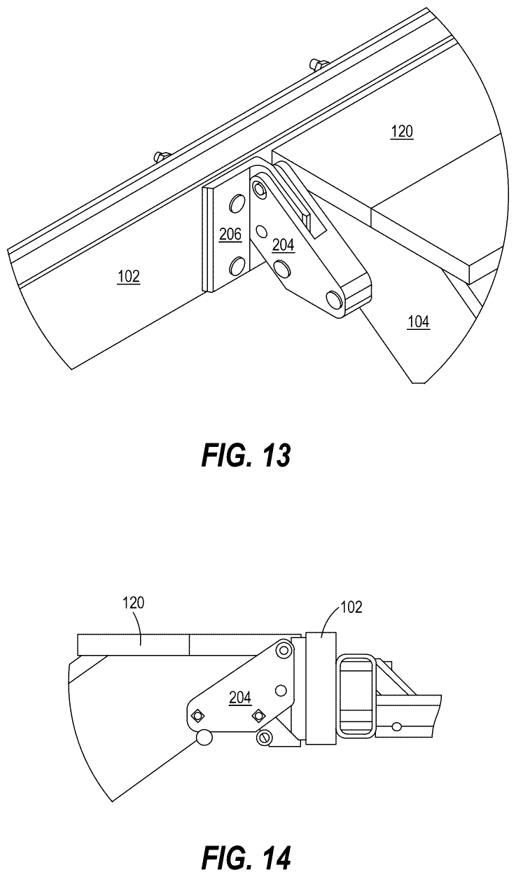

Referring now to FIG. 12, a perspective front view of the hinge mechanism 114 in a semi-exploded configuration is depicted, according to an embodiment of the present disclosure. This view illustrates how the components of the hinge mechanism 114, specifically the female bracket 204 and the male bracket 206, are designed to interact with one another. The first leaf 700 and the second leaf 702 of the female bracket 204 are shown in relation to the receiving slot 704, prepared to engage with the male bracket 206. The male bracket 206, comprising the first foil 800 and the second foil 802, demonstrates the L-shape configuration of its design, in alignment with the receiving slot 704 of the female bracket 204. This semi-exploded view illustrates the assembly process and the interlocking mechanism that facilitates the pivotal movement necessary for the operation of the aquatic stairs 100.

Referring now to FIG. 13 and FIG. 14. In FIG. 13 a perspective top view of hinge mechanism 114 is illustrated, depicting its integral role in connecting aquatic stairs 100 of FIG. 1 to support structure 102. In FIG. 14, a schematic side view is presented of hinge mechanism 114 as it adjoins aquatic stairs 100 of FIG. 1 to support structure 102, in accordance with an embodiment of the present disclosure. In this embodiment, hinge mechanism 114 is shown in its operational state, affixed to support structure 102. The top view offers insight into the precise arrangement of components comprising hinge mechanism 114, including the placement of fasteners and articulation points that enable pivotal movement at the first end 120. This configuration is designed to support the functional demands placed upon aquatic stairs 100, ensuring a seamless pivotal integration with support structure 102. The side view further illustrates the means by which hinge mechanism 114 facilitates the pivotal movement of aquatic stairs 100 relative to support structure 102 and the first end 120.

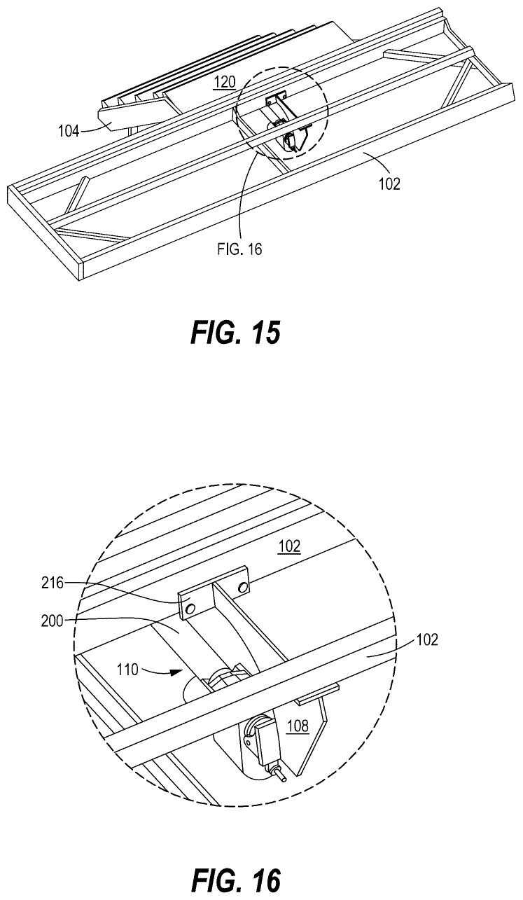

FIG. 15 is a perspective top view of the support structure 102 in conjunction with aquatic stairs 100 as depicted in FIG. 1, placing emphasis on actuator 110 in accordance with an embodiment of this disclosure. In this embodiment, actuator 110 is strategically positioned to interface with the staircase 104, providing the necessary mechanical force to transition the staircase 104 between elevated or raised positions and access or submerged lowered positions. The support structure 102 is a pier, as generally known in the arts. The actuator 110 may be mounted to the anchor 108 on the underside of the pier. In FIG. 16, a perspective close-up view of the actuator 110 is rendered, highlighting the actuator 110 as it is affixed to the aquatic stairs 100 from FIG. 15 below the support structure 102, according to an embodiment of the present disclosure.

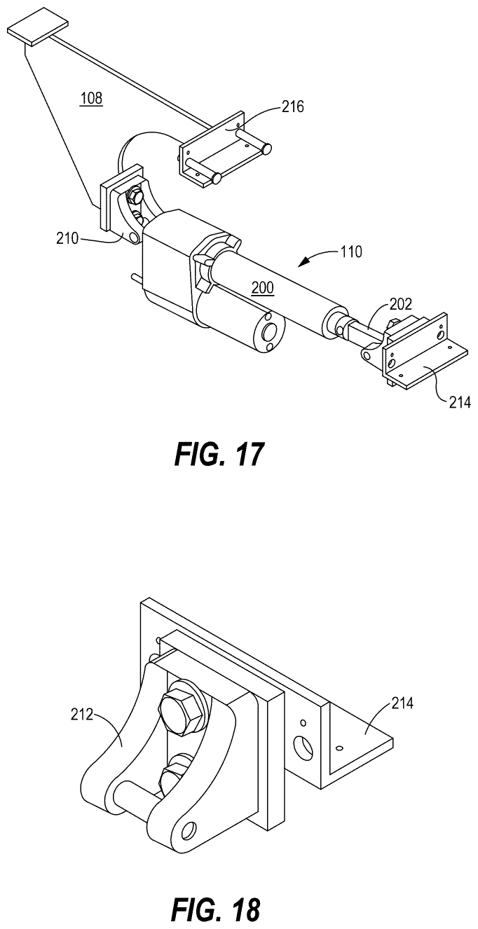

FIG. 17 presents a perspective isolated view of actuator 110 as it is affixed to anchor 108, pursuant to an embodiment of the present disclosure. This depiction isolates actuator 110, allowing for an unobstructed examination of its structure and the manner in which it is mounted to anchor 108. This view is instrumental in conveying the relationship between actuator 110, the anchor 108, the first actuator pivot bracket 210, the second actuator pivot bracket 212, the actuator-stair bracket 214, and the power-stairs bracket 216 for pivotably moving the staircase 104. The isolated perspective of actuator 110 clarifies the design elements that contribute to the robust and effective operation of the aquatic stairs 100.

FIG. 18 depicts a perspective view of the second actuator pivot bracket 212 and the actuator-stair bracket 214, in accordance with an embodiment of the present disclosure. The second actuator pivot bracket 212 is configured to integrate with the actuator-stair bracket 214 and further configured to providing a pivotable point for an end of the actuator 110 for the operation of the aquatic stairs 100.

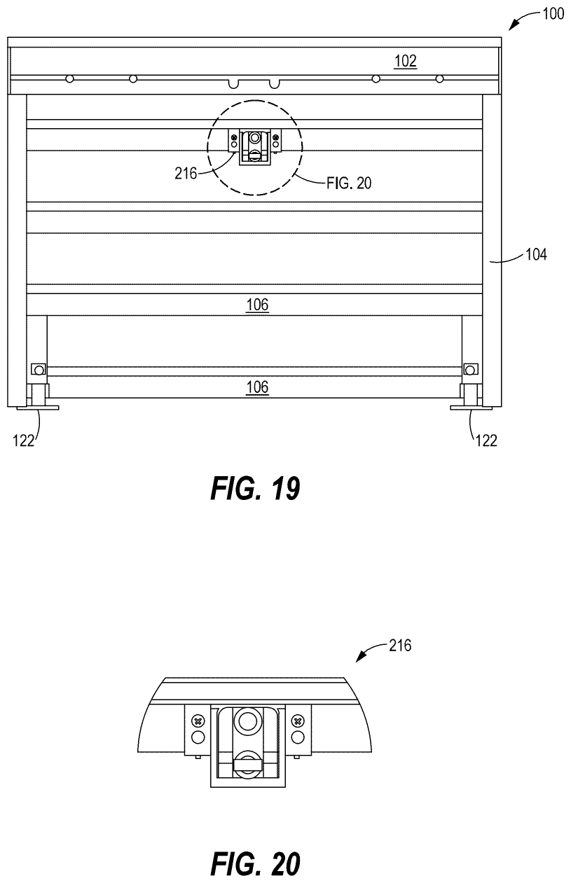

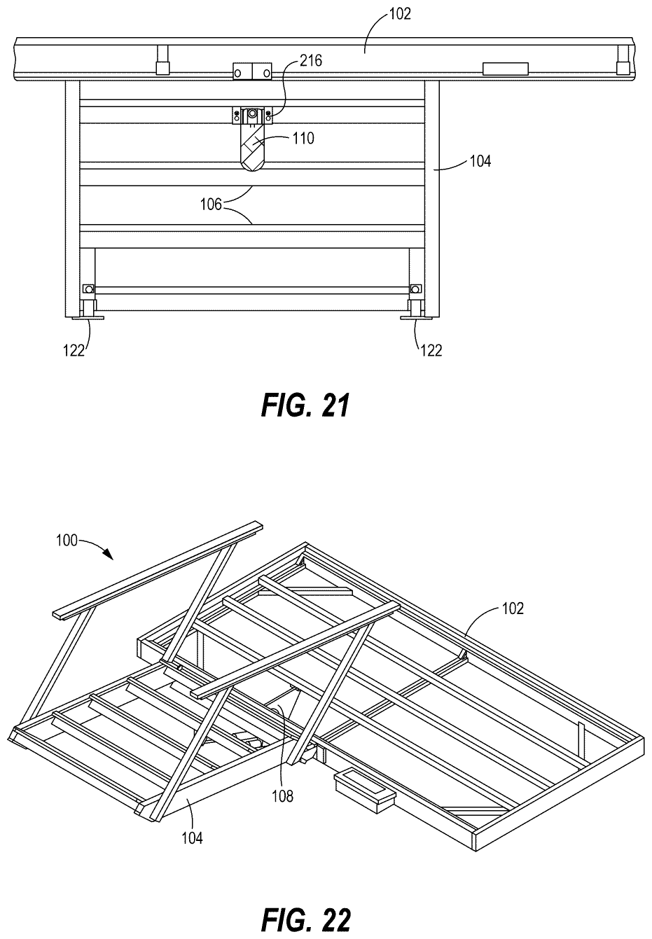

Now referring to FIGS. 19-22. FIG. 19 shows a schematic front view of aquatic stairs 100 in an access orientation, pursuant to an embodiment of the present disclosure. FIG. 20 illustrates a schematic front view of power-stair bracket 216, aligned with an embodiment of the present disclosure. FIG. 21 illustrates a schematic rear view of aquatic stairs 100 in the access orientation is illustrated, according to an embodiment of the present disclosure. The rear view provides an insight into the structural arrangement and the relative positions of the various elements when aquatic stairs 100 are set for access to afford safe and efficient passage to users. The positioning of the power-stair bracket 216 is illustrated showing the position of the actuator 110 relative to the support structure 102. These views illustrate the secure attachment and position of the actuator 110 to the support structure 102.

Lastly, FIG. 22 is a perspective top view of support structure 102 and aquatic stairs 100 in a lifted orientation, according to an embodiment of the present disclosure. This vantage point illustrates the positioning of aquatic stairs 100 when elevated, revealing the interaction between the support structure 102, actuator 110, staircase 104 and other related mechanisms.

### INDUSTRIAL APPLICABILITY

In operation, the present disclosure may find applicability in various waterfront settings including, but not limited to, residential docks, commercial marinas, waterfront properties, and public access points to bodies of water. Specifically, the systems, apparatuses, and methods of the present disclosure may be utilized for adjusting aquatic staircases for access between aquatic and terrestrial environments, including, but not limited to, boat launches, swimming platforms, waterfront gangways, and similar structures facilitating water access. While the foregoing detailed description is made with specific reference to aquatic stairs 100, it is to be understood that its teachings may also be applied to other water access structures such as riverbank stairs, boat docks, and the like. The aquatic stair system 400 may be provided as a retrofit or an integral part of new installations in these various applications that require adaptable access to water.

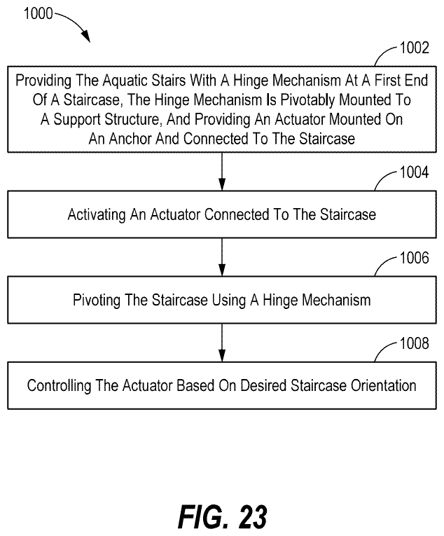

Referring now to FIG. 23, a flow-chart outlines a method 1000 for adjusting the position of the staircase 104 relative to the water line 116, according to an embodiment of the present disclosure. The method 1000 provides an approach for transitioning the staircase 104 between its various orientations, thereby facilitating seamless access in aquatic environments near lakes, rivers, streams, and the like.

The method 1000 commences with a step 1002, where the aquatic stairs 100 are provided with a pivotal mounting mechanism at the first end 120, incorporating a hinge mechanism 114 to securely attach to the support structure 102. This provides pivotable movement of the aquatic stairs 100, ensuring a stable yet adjustable connection to the waterfront infrastructure. Simultaneously, the actuator 110 is mounted onto the anchor 108 providing a mechanical connection between the actuator 110 and the aquatic stairs 100 configured for maneuvering the staircase 104.

In step 1004, the method 1000 begins with the activation of the actuator 110 connected to the staircase 104. This activation, via the control unit 402, is the initial trigger that sets the entire adjustment process in motion, utilizing the actuator 110's capability to extend and retract, which directly influences the positioning of the staircase 104.

Proceeding to step 1006, the staircase 104 undergoes a pivoting action facilitated by a hinge mechanism 114. In step 1006, the staircase 104 is enabled to pivot relative to the support structure 102, adjusting its angle and orientation in a controlled manner. The hinge mechanism 114's design ensures smooth and stable pivoting, essential for the seamless operation of the staircase 104.

In the final step 1008, the actuator 110's operation is controlled based on the desired orientation of the staircase 104. This control is achieved through a combination of manual inputs, sensor feedback, and pre-determined settings within the control unit 402. The movement of the actuator 110 is fine-tuned to achieve the precise positioning of the staircase 104, whether it is being elevated above the water line 116 for safety and maintenance, lowered to provide access to the water or a boat, or oriented in any position between fully lifted and fully submerged.

The method 1000 provides effective procedure for adjusting aquatic staircases, ensuring their functionality and reliability in providing access between aquatic and terrestrial environments. This method 1000 highlights the integrated use of mechanical and control systems to achieve adaptable and user-oriented operation of aquatic staircases in various waterfront settings.

The aquatic stairs 100, as disclosed herein, are ingeniously designed to ensure adaptability to a wide range of environmental conditions, encompassing both freshwater and saltwater environments. This adaptability is achieved through the thoughtful selection of materials and the incorporation of design features that safeguard the stairs against the deleterious effects of weathering, UV damage, and temperature extremes. For instance, the staircase 104 and support structure 102 are fabricated from materials known for their corrosion resistance and durability in aquatic settings. Additionally, the hinge mechanism 114 and actuator 110 are engineered to maintain functional integrity and resist degradation, even when continuously subjected to the marine elements. This construction ensures that the aquatic stairs 100 remain a reliable access solution, irrespective of the environmental challenges posed by their installation site.

Furthermore, protective coatings may be applied to the aquatic stairs 100 to enhance the durability and functionality in marine environments. These coatings, applied to components such as the staircase 104, actuator 110, and hinge mechanism 114, are designed to provide resistance against corrosion, UV damage, and biofouling. The incorporation of such coatings ensures the longevity of the aquatic stairs 100, minimizing maintenance requirements and preserving structural integrity over prolonged exposure to harsh marine conditions.

From the foregoing, it can be seen that the technology disclosed herein has industrial applicability in various waterfront environments, including, but not limited to, residential docks, commercial marinas, public access points, and private waterfront properties.

What is claimed is:

1. Aquatic stairs for marine environments, comprising:
a staircase; and
an aquatic stair system for elevating a staircase from a body of water, including:
a hinge mechanism for attaching the staircase to a support structure; and
an actuator operatively connected to the staircase for transitioning the staircase between submerged and elevated positions.

2. The aquatic stairs of claim 1, wherein the actuator comprises a linear actuator capable of extending and retracting to facilitate the elevation and lowering of the staircase.

3. The aquatic stairs of claim 1, the aquatic stair system further including a control unit configured to regulate the operation of the actuator based on input commands for desired staircase positions.

4. The aquatic stairs of claim 1, wherein the hinge mechanism includes a male bracket affixed to the support structure and a female bracket affixed to the staircase, enabling pivotal movement of the staircase relative to the support structure.

5. The aquatic stairs of claim 4, wherein the female bracket is equipped with a receiving slot designed to engage with the male bracket, facilitating a secure yet pivotable connection between the staircase and the support structure.

6. The aquatic stairs of claim 1, the aquatic stair system further including a sensor associated with the actuator for monitoring the position of the staircase and providing feedback to ensure accurate positioning of the staircase.

7. The aquatic stairs of claim 3, wherein the control unit is operatively connected to an operator interface or a mobile remote, allowing manual control over the position of the staircase.

8. An aquatic stair system for transitioning a staircase between elevated and submerged positions relative to a body of water, comprising:
an actuator mounted to a support structure, wherein the actuator is capable of extending and retracting to adjust the orientation of the staircase;
a hinge mechanism attached to the support structure and operatively connected to the staircase, facilitating pivotal movement of the staircase in response to the actuator;
a control unit configured to command the actuator based on desired staircase orientation.

9. The aquatic stair system of claim 8, wherein the actuator comprises an actuator cylinder and an actuator rod, the actuator rod capable of moving within the actuator cylinder to facilitate the linear motion required for adjusting the staircase.

10. The aquatic stair system of claim 8, further comprising an actuator pivot bracket connecting the actuator to the staircase, allowing the actuator to pivot relative to the staircase and accommodate changes in the angle of the staircase during transition between positions.

11. The aquatic stair system of claim 8, wherein the hinge mechanism includes a female bracket affixed to the staircase and a male bracket affixed to the support structure, the female bracket configured to engage with the male bracket to enable the pivotal movement of the staircase.

12. The aquatic stair system of claim 11, wherein the female bracket comprises a first leaf and a second leaf, and the male bracket comprises a first foil and a second foil forming an L-shape, the L-shape of the male bracket facilitating a secure connection to the support structure.

13. The aquatic stair system of claim 8, further comprising an operator interface connected to the control unit, the operator interface allowing a user to manually input commands for the desired positioning of the staircase.

14. The aquatic stair system of claim 13, further comprising a mobile remote capable of wireless communication with the control unit, the mobile remote allowing for remote adjustment of the staircase's position.

15. The aquatic stair system of claim 8, wherein the sensor is an actuator sensor configured to detect the extension or retraction length of the actuator rod, providing data to the control unit for the accurate positioning of the staircase.

16. A method for adjusting a position of aquatic stairs relative to a body of water, the method comprising:
providing the aquatic stairs with a hinge mechanism at a first end of a staircase, the hinge mechanism is pivotably mounted to a support structure, and providing an actuator mounted on an anchor and connected to the staircase;
activating the actuator connected to the staircase;
pivoting the staircase using the hinge mechanism; and
controlling the actuator based on desired staircase orientation.

17. The method of claim 16, wherein activating the actuator involves extending or retracting an actuator rod within an actuator cylinder to achieve the desired adjustment of the staircase.

18. The method of claim 16, further comprising monitoring the position of the staircase using a sensor connected to the actuator to provide real-time feedback for precise control of the staircase orientation.

19. The method of claim 16, wherein pivoting the staircase involves engaging a male bracket of the hinge mechanism affixed to a support structure with a female bracket of the hinge mechanism affixed to the staircase.

20. The method of claim 16, further comprising manually inputting commands through an operator interface or mobile remote connected to a control unit that regulates the operation of the actuator.
